(19) United States
(12) Patent Application Publication
(10) Pub. No.: US 2021/0028437 A1
(43) Pub. Date: Jan. 28, 2021

(54) METHOD OF MAKING AN ELECTRODE WITH PROTECTION LAYERS

(71) Applicant: AAB Technology (HK) Limited, Kowloon (HK)

(72) Inventor: Zhonglai Pan, Hong Kong (CN)

(21) Appl. No.: 16/938,834

(22) Filed: Jul. 24, 2020

Related U.S. Application Data
(60) Provisional application No. 62/879,172, filed on Jul. 26, 2019.

(30) Foreign Application Priority Data
May 27, 2020 (CN) 202010460653.3

(51) Int. Cl. H01M 4/04; B05D 1/18; H01M 4/62; H01M 4/36; H01M 4/505; H01M 4/50; H01M 4/1391; H01M 4/131

(52) U.S. Cl. CPC H01M 4/0471; B05D 1/18; H01M 4/0402; H01M 4/628; H01M 2004/028; H01M 4/505; H01M 4/502; H01M 4/1391; H01M 4/131; H01M 4/366

(57) ABSTRACT

A method of making an electrode with protection layers is provided. The method comprising the steps of withdrawing an immersed electrode from a coating liquid at an angle perpendicular to a surface of the coating liquid at a speed from about 1 mm/s to about 9 mm/s; and drying the electrode to obtain an electrode with protection layers. The coating liquid can be a dispersion liquid or a liquid comprising an upper layer and a lower layer; wherein the upper layer is the dispersion liquid and the lower layer is water. The dispersion liquid comprises graphene or a graphene derivative.

### CROSS REFERENCE TO RELATED APPLICATIONS

This application claims priority to U.S. Provisional Patent Application No. 62/879,172 filed on Jul. 26, 2019, and China Patent Application No. 202010460653.3 filed on May 27, 2020; each of which is hereby incorporated by reference in its entirety.

### FIELD OF THE INVENTION

The present invention relates to a method of making an electrode with protection layers, relating to the technical field of secondary batteries.

### BACKGROUND OF THE INVENTION

With the escalating demands towards smaller portable devices and electric vehicles, suitable sustainable power sources are being sought that are efficient, compact, lightweight and safe. Rechargeable batteries are commonly used as power sources, adjusting to meet the demands of more powerful low cost large grid-scale energy storage systems. Although, lithium ion batteries offer great advantages due to their high electron density and low self discharge rate; the high cost, low abundance and poor safety issues associated with flammable organic electrolytes, alternatives have been considered. Recently, various aqueous electrolyte based rechargeable batteries have been sought after that possess safe, high power, large grid-scale energy storage systems. In particular, aqueous electrolyte batteries containing zinc ions have shown to be promising due to their abundance, higher stability, low cost, and nontoxic properties, making these aqueous rechargeable zinc batteries particularly attractive.

Manganese-based cathode materials have been commonly used as cathode materials in rechargeable batteries, including aqueous rechargeable zinc batteries, due to their numerous oxidation states (2⁺, 3⁺, 4⁺) giving manganese the ability to exploit a high number of redox couples, providing batteries of high thermal stability, inexpensive, environmentally safe, high capacity and long storage life. However, there are complications associated with these types of batteries.

Battery cell performance of these manganese-based aqueous rechargeable zinc rechargeable batteries are often limited during the repeated charging and discharging process, by decrease in capacity which can lead to shorter battery cycle life. Conductive network failure can be attributed to conductive agent oxidation forming unwanted by-products under both low and high potential. Furthermore, poor cycling performance can be attributed to the formation of inactive side products on cathode surface originated from the manganese ion dissolution. The Jahn-Teller distortion effect of these manganese-based cathodes can also lead to the lithium accumulation which would aggravate manganese ion dissolution, resulting in the battery capacity decay. Additionally, due to the oxygen environment generated from water decomposition, carbon oxidation issue may cause the conductive network failure which could further limit battery cycle life. All of these aforementioned side reactions could contribute significantly to the cycle life decay of rechargeable batteries.

Attempts to overcome these problems have been addressed to prevent degradation of the cathode, and extend the life cycle of the battery, which include doping, or applying protective coating additives to increase structural stability during electrochemical cycling process.

Protection layers with graphene have been added to a positive pole material layer to improve battery performance. Typically, dispersion liquids include organic solvents to disperse and carry graphene or graphene derivatives on to a sub-phase surface, by dripping the dispersion liquid on to LB film formation equipment to spread the graphene or graphene derivative on to the surface. After a period of time, the organic solvent volatizes, leaving the graphene or graphene derivative particles spread on the sub-phase surface. Sliding barriers can be used to compress the graphene or graphene derivative particles spread on the sub-phase surface to a preset film forming mold, so that a dense nano-film of graphene or graphene derivative is formed on the sub-phase surface. Then, the graphene or graphene derivative film is transferred to the active material of the positive pole.

However, there are disadvantageous associated with many of these methods which include utilizing vertical pulling, horizontal attachments or sub-phase decrease, etc. These aforementioned methods can be complex, may require special equipment and can be costly.

For the foregoing reasons, there exists a need for methods of making electrodes with protective layers in aqueous rechargeable batteries which are versatile and efficient. Further, it would be advantageous to have these method to be safe, effective and low cost.

### SUMMARY

The present disclosure is directed to methods of making an electrode with protection layers. In accordance with the present invention, the method comprising the steps of withdrawing an immersed electrode from a coating liquid at an angle perpendicular to a surface of the coating liquid at a speed from about 1 mm/s to about 9 mm/s to form a coated electrode; and drying the electrode to obtain an electrode with protection layers. The coating liquid can be a dispersion liquid or a liquid comprising an upper layer and a lower layer; wherein the upper layer is the dispersion liquid and the lower layer is water. The dispersion liquid comprises graphene or a graphene derivative or combinations thereof.

According to an embodiment of the present disclosure, the dispersion liquid is obtained by the following steps; forming a reaction mixture comprising one or more of the graphene, graphene derivative or combinations thereof, and a first solvent. The graphene or graphene derivative typically is weighed and a first solvent is added to form the reaction mixture. The reaction mixture is then stirred subsequently followed by subjecting the reaction mixture to ultrasonic treatment. A second solvent is then added to the reaction mixture and the reaction mixture is stirred to obtain the dispersion liquid. The stirring can occur by magnetic stirring.

In an embodiment of the present disclosure, the first solvent contains water, alcohol, ester or ketone. The second solvent contains water, alcohol, haloalkane ether or ketone.

In a preferred embodiment of the disclosure, the first solvent contains methanol, ethanol, isopropanol or acetone. The second solvent contains ethanol, 1,2-dichloroethane, chloroform and acetone.

In an embodiment of the present disclosure, the volume ratio of the first solvent to that of the second solvent is from about 1:1 to about 1:20. Preferably, the volume ratio of the first solvent to that of the second solvent is from about 1:5 to about 1:15.

In an embodiment of the disclosure, the graphene or graphene derivative or combinations thereof is present in the dispersion liquid in a concentration from about 0.025 mg/mL to about 1 mg/mL. In a preferred embodiment of the disclosure, the graphene or graphene derivative is present in the dispersion liquid in a concentration from about 0.075 mg/mL to about 1 mg/mL.

In an embodiment of the disclosure the electrode is immersed into the coating liquid and withdrawn from the coating liquid at a uniform speed.

In a preferred embodiment of the disclosure, the coating liquid is a dispersion liquid.

In an embodiment of the disclosure, the electrode is immersed into the coating liquid at an angle perpendicular to a surface of the coating liquid at a uniform speed from about 1 mm/s to about 9 mm/s, prior to the step of withdrawing; and after a period of time, the electrode is withdrawn from coating liquid at an angle perpendicular to the surface of the coating liquid at a uniform speed from about 1 mm/s to about 9 mm/s.

In an embodiment of the disclosure, wherein the period of time is from about 5 s to about 60 s.

In an embodiment of the disclosure, the following steps are repeated at least once: drying the electrode moved out, immersing it perpendicularly into the surface of the coating liquid and then taking the electrode out perpendicularly from the surface of the coating liquid at a uniform speed from about 1 mm/s to about 9 mm/s.

In a most preferred embodiment of the disclosure, a method of making an electrode with protection layers is provided, the method comprising the steps of: a) immersing an electrode into a coating liquid at an angle perpendicular to a surface of the coating liquid at a uniform speed from about 1 mm/s to about 9 mm/s to form the immersed electrode; b) withdrawing the immersed electrode from the coating liquid at an angle perpendicular to a surface of the coating liquid at a uniform speed from about 1 mm/s to about 9 mm/s to form a coated electrode; and, c) drying the coated electrode to obtain the electrode with protection layers; wherein the coating liquid comprises a dispersion liquid; whereby the dispersion liquid comprises one or more of graphene, a graphene derivative and combinations thereof.

In an embodiment of the present disclosure, repeating the aforementioned steps (a)-(c) can be repeated at least once to obtain the electrode with protection layers.

In an embodiment of the disclosure, the graphene derivative is graphene oxide and reduced graphene oxide.

In an embodiment of the disclosure the electrode is a cathode.

In an embodiment of the disclosure, the cathode is prepared by the following method. A cathode active material, a conductive agent an adhesive and a solvent are mixed to form a reaction mixture and stirred to obtain a cathode paste. Next, the cathode paste is applied on to a collector and dried to obtain the cathode.

In an embodiment of the disclosure, the cathode active material contains at least one or more material(s) with formula Li₁₊ₓMn_{y}M_{z}Oₖ, wherein −1≤x≤0.5, 1≤y≤2.5, 0≤z≤1 and 3≤k≤6.

In an embodiment of the disclosure, the cathode active material is selected from at least one of LiMn₂O₄ and MnO₂.

The method of the present disclosure can be used to prepare an electrode with protection layers to improve the cycle performance of batteries. The method is simple and highly operable. The methods of the present disclosure have the following significant advantages. No special equipment is required, contributing to low cost. Additionally, no poisonous agents, such as hydrazine hydrate will be used in this method, making it safe, environmentally friendly and applicable to industrial mass production.

### BRIEF DESCRIPTION OF THE DRAWINGS

These and other features, aspects, and advantages of the present disclosure will become better understood with reference to the following description, appended claims and accompanying drawings wherein:

FIG. 1 is a schematic diagram illustrating even keel coating and suspension coating methods according to embodiments of the present disclosure.

FIG. 2 illustrates the cycle performance of a battery comprising a cathode obtained after even keel coating methods and suspension coating methods according to an embodiment of the present disclosure.

FIG. 3 illustrates the cycle performance of batteries comprising cathodes obtained with a coating layer comprising a graphene derivative using the even keel and suspension coating methods of making an electrode with protection layers as described in Examples 1-3 according to an embodiment of the present disclosure.

FIG. 4 illustrates the cycle performance of a battery comprising the cathode obtained with a coating layer comprising a graphene derivative as described in Reference 1 according to an embodiment of the present disclosure.

FIG. 5 illustrates the cycle performance of batteries comprising the cathode obtained in with a coating layer comprising graphene and graphene derivatives as described in Examples 4 and 5 and Reference 2 according to an embodiment of the present disclosure.

These and other features, aspects, and advantages of the present invention will become better understood with reference to the following description.

### DETAILED DESCRIPTION OF EMBODIMENTS

The present disclosure provides a method of making an electrode with protection layers comprising the steps of: withdrawing an immersed electrode from a coating liquid at an angle perpendicular to a surface of the coating liquid at a speed from about 1 mm/s to about 9 mm/s; and drying the electrode to obtain an electrode with protection layers. The coating liquid can be a dispersion liquid or a liquid comprising an upper layer and a lower layer; wherein the upper layer is the dispersion liquid and the lower layer is water. The dispersion liquid comprises graphene or a graphene derivative or a combination thereof.

In an embodiment of the present disclosure, the dispersion liquid is a liquid with solid particles uniformly dispersed therein.

Preferably, the solid particles comprise graphene, wherein graphene is dispersed in the liquid forming a graphene dispersion liquid.

In another embodiment, the solid particles comprise a graphene derivative, wherein the graphene derivative is dispersed in the liquid forming a graphene derivative dispersion liquid.

The electrode in the present disclosure can be a cathode or an anode. Preferably, the electrode is composed of a collector and active materials located on the collector surface.

The electrode with protection layers typically is an electrode which has at least one protection layer on its outer surface. Typically, the protection layer is located on the surface of the active material away from the collector. Preferably the protection layer comprises graphene. More preferably, the protection layer is composed of graphene or a graphene derivative.

Preferably the graphene derivative in the disclosure is graphene oxide or reduced graphene oxide.

According to the method in the disclosure, the electrode is perpendicularly withdrawn from the surface of the coating liquid containing the dispersion liquid; and the graphene or graphene derivative is distributed or attached onto the electrode surface. After the electrode with the coating liquid is dried, an electrode with a protection layer is obtained. Advantages to this method include a simple method to prepare electrodes with graphene protection layers of good performance, requiring no special equipment, and without the need of special adhesives.

The derivative dispersion liquid can be prepared with any conventional method known to those skilled in the art to uniformly disperse the graphene or graphene derivative. In an embodiment of the present disclosure, the dispersion liquid can be prepared by the following steps: adding the graphene or graphene derivative into a first solvent (solvent 1) forming a reaction mixture; stirring the reaction mixture and subjecting the reaction mixture to ultrasonic treatment; the adding a second solvent (solvent 2) to the reaction mixture containing the graphene or graphene derivative, or adding the reaction mixture to the second solvent (solvent 2); and, stirring the mixture to obtain the dispersion liquid.

In an embodiment of the present disclosure, the first solvent contains water, alcohol, ester or ketone. The second solvent contains water, alcohol, haloalkane, ether or ketone.

In a preferred embodiment of the present disclosure, the first solvent contains methanol, ethanol, isopropanol or acetone. The second solvent contains ethanol, 1,2-dichloroethane, chloroform and acetone. Preferably, any combination of the first solvent and second solvent will not influence dispersion effect and performance of the obtained electrode with protection layer. For example, solvent 1 and solvent 2 can be water, ethanol or acetone, or any combination of different solvents, such as the combination of methanol and ethanol, methanol and 1,2-dichloroethane, methanol and chloroform, methanol and acetone, ethanol and 1,2-dichloroethane, ethanol and chloroform, ethanol and acetone, isopropanol and ethanol, isopropanol and 1,2-dichloroethane, isopropanol and chloroform, isopropanol and acetone, acetone and ethanol, acetone and 1,2-dichloroethane, acetone and chloroform, etc.

In an embodiment, the volume ratio of the first solvent to the second solvent (solvent 1 to that of solvent 2) is typically from about 1:1 to about 1:20 respectively. In a preferred embodiment of the disclosure, the volume ratio of solvent 1 to that of solvent 2 is from about 1:5 to about 1:15 respectively. In some embodiments of the disclosure, the volume ratio of volume solvent 1 to that of solvent 2 can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, etc.

In an embodiment, the concentration of graphene in the dispersion liquid is from about 0.025 mg/mL to about 1 mg/mL. In a preferred embodiment, the concentration of graphene in the dispersion liquid is from about 0.075 mg/mL to about 1 mg/mL. In some embodiments of the disclosure, the concentration of graphene can be 0.075 mg/mL, 0.08 mg/mL, 0.1 mg/mL, 0.12 mg/mL, 0.15 mg/mL, 0.18 mg/mL, 0.2 mg/mL, 0.21 mg/mL, 0.23 mg/mL, 0.25 mg/mL, 0.4 mg/mL, 1 mg/mL, etc.

In accordance with the present disclosure, by withdrawing the coated electrode from the coating liquid at a specific angle and speed, the graphene or graphene derivative can be distributed and attached on to the electrode surface, thus obtaining an electrode with at least one protection layer.

In a preferred embodiment of the present disclosure, it has been shown that the speed is the key advantage in the methods described herein of making an electrode with protective layer(s). Excessive speed can influence the uniformity of the graphene or graphene derivative layer, and can even cause failure to apply the protection layer, thus influencing the performance of the electrode. Insufficient speed can increase operation cost and result in a large difference between the immersed end and the non-immersed end of the electrode when the electrode is moved out, which can result in non-uniform thickness of the protection layer that can adversely affect the battery cycle performance. In a most preferred embodiment of the present disclosure, when the immersed electrode is withdrawn from the surface of the coating liquid at a speed from about 1 mm/s to about 9 mm/s, this results in better performance achieved for the electrode with protection layers.

In yet another preferred embodiment of the present disclosure, it has been shown that the angle from which the electrode is immersed and/or withdrawn from the coating liquid can also influence the quality of the protection layer(s). Preferably, the electrode is immersed and/or withdrawn at an angle that is perpendicular the surface of the coating liquid. “Perpendicular” is referred to herein as the axis of the electrode which is vertical to the surface of the coating liquid containing the dispersion liquid. Typically, perpendicular withdrawal and immersion is controlled mainly to expedite downflow of the dispersion liquid retained on the electrode surface and to prevent redundant dispersion liquid from retaining on the electrode surface which can cause the protection to have a rough surface due to the generation of uneven lump-like defects.

Typically, the electrode is withdrawn from the coating liquid at a uniform speed or a variable speed, which should be controlled within the range of from about 0.1 to about 10 mm/s. Preferably the speed is from about 1 mm/s to about 9 mm/s. In some embodiments of the disclosure, the electrode can be moved out at a speed of 1 mm/s, 1.5 mm/s, 1.7 mm/s, 2 mm/s, 2.4 mm/s, 2.8 mm/s, 3 mm/s, 3.5 mm/s, 4 mm/s, 4.4 mm/s, 5 mm/s, 5.5 mm/s, 6 mm/s, 6.5 mm/s, 7 mm/s, 7.5 mm/s, 8 mm/s, 8.4 mm/s, etc.

Those skilled in the art can appreciate that if the electrode is withdrawn or moved out of the coating liquid containing the dispersion liquid at too low of a speed, the preparation of making the electrode with protective layers will consume too much time which is not conducive to industrial mass production.

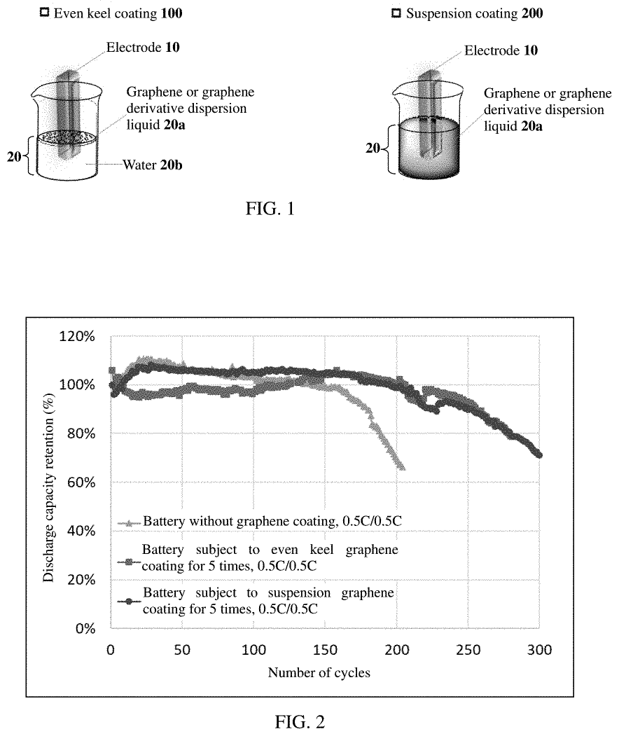

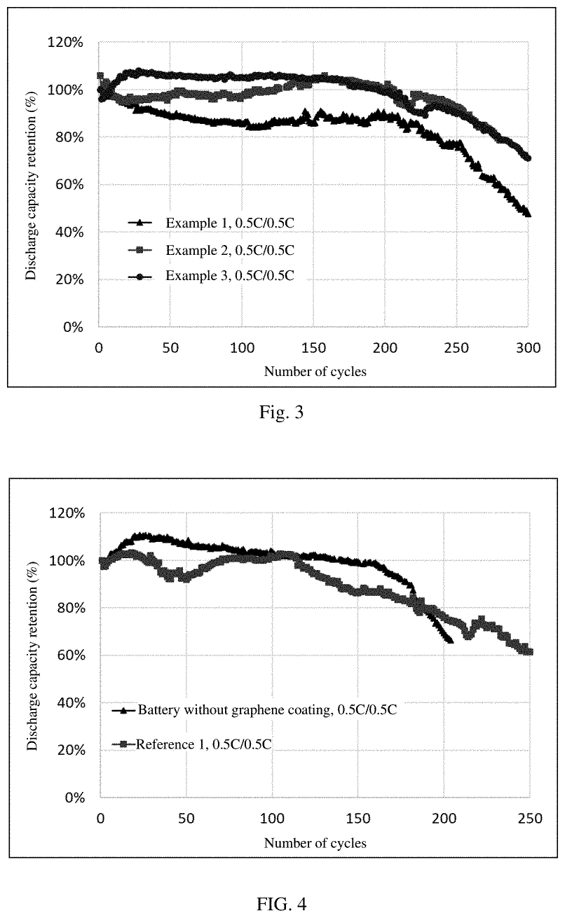

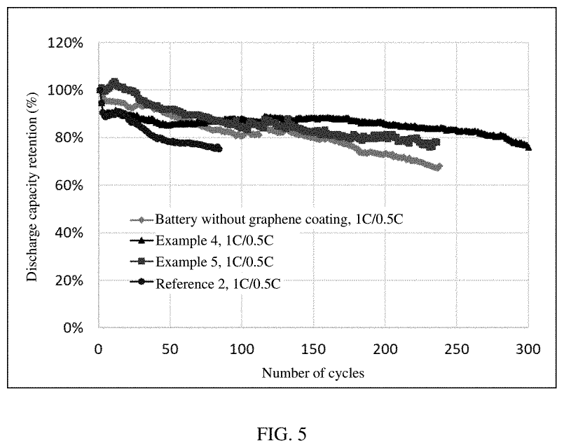

In the present disclosure, the coated electrode can be formed by an even keel coating 100 or a suspension coating 200. In one embodiment of the disclosure, as shown in FIG. 1, even keel coating 100 means that the coating liquid 20 contains dispersion liquid 20a at the upper layer and water 20b at the lower layer. The electrode 10 is completely immersed into the lower layer containing water 20b at a certain speed, and an upper layer of dispersion liquid 20a is spread on the water 20b surface. Next, the electrode 10 is withdrawn from the water 20b at a certain speed, thus coating is completed forming the coated electrode. In yet an alternative embodiment, for suspension coating 200, the coating liquid 20 preferably is the dispersion liquid 20a. The electrode is immersed into the dispersion liquid 20a at a certain speed and then withdrawn or pulled out at a certain speed, thus coating is completed resulting in a coated electrode.

In an embodiment of the disclosure, when the coating liquid 20 is the dispersion liquid 20a, the electrode is perpendicularly immersed into the coating liquid 20 at a uniform speed from about 1 mm/s to about 9 mm/s and, after a period of time, the electrode is moved out from the coating liquid 20 perpendicularly at a speed from about 1 mm/d to about 9 mm/s.

In accordance to an embodiment of the present disclosure, the electrode 10 can be immersed in and withdrawn from the coating liquid 20 at a variable speed or a uniform speed; and the speed of immersion and withdrawal can be the same or different. In one embodiment, the electrode 10 is immersed into the coating liquid perpendicularly at a speed of about 1 mm/s and, after a period of time, is moved out from the coating liquid 20 perpendicularly at a speed of about 1 mm/s. In another embodiment, the electrode 10 is immersed into the coating liquid 20 perpendicularly at a speed of about 8 mm/s and, after a period of time, is moved out from the coating liquid perpendicularly at a speed of about 1 mm/s. In another embodiment, the electrode 10 is immersed into the coating liquid 20 perpendicularly at a speed of about 5 mm/s and, after a period of time, is moved out from the coating liquid perpendicularly at a speed of about 5 mm/s. In another embodiment, the electrode 10 is immersed into the coating liquid 20 perpendicularly at a speed of about 5 mm/s and, after a period of time, is moved out from the coating liquid perpendicularly at a speed of about 3 mm/s. In yet another embodiment, the electrode 10 is immersed into the coating liquid 20 perpendicularly at a speed of about 3 mm/s and, after a period of time, is moved out from the coating liquid perpendicularly at a speed of about 3 mm/s. In another embodiment, the electrode 10 is immersed into the coating liquid 20 perpendicularly at a speed of about 3 mm/s and, after a period of time, is moved out from the coating liquid 20 perpendicularly at a speed of about 6 mm/s. In another embodiment, the electrode pad is immersed into the coating liquid 20 perpendicularly at a speed of about 6 mm/s and, after a period of time, is withdrawn from the coating liquid perpendicularly at a speed of about 6 mm/s.

According to an embodiment of the present disclosure, the period of time the electrode 10 is immersed can be referred to as immersing time duration, and can have certain influence on the preparation of the electrode protection layer. Preferably, the immersing time duration is from about 5 s to about 60 s. If the immersing time duration is controlled within such range, the obtained electrode with protection layers feature favorable performance. In some embodiments of the disclosure, the immersing duration can be 5 s, 7 s, 10 s, 12 s, 15 s, 18 s, 20 s, 22 s, 24 s, 25 s, 27 s, 29 s, 30 s, 32 s, 35 s, 37 s, 40 s, 42 s, 45 s, 48 s, 50 s, 52 s, 55 s, 58 s, 60 s, etc.

In accordance to an embodiment of the present disclosure, in order to improve the coating effect and/or for example, provide the electrode with a plurality of protection layers, coating can be performed only once or many times. For example, the following steps can be repeated at least once: withdrawing the immersed electrode, and after drying, immersing the electrode perpendicular the surface of the coating liquid, and moving the coated electrode out of the coating liquid perpendicularly at a speed from about 1 mm/s to about 9 mm/s. Preferably, the method of coating is repeated four times, i.e., coating is performed five times total.

FIG. 2 illustrates at a charging/discharging rate of 0.5C, the performance of the battery comprising cathode with a graphene protection layer coated for 5 times, wherein the concentration of graphene dispersion liquid is 0.075 mg/mL. The detailed experiment conditions and battery cycle performance data are shown in Table 1.

TABLE 1

| | cathode | cathode | |
|---|---|---|---|
| | immersion speed | move-out speed | Battery |
| | (mm/s) | (mm/s) | performance |
| Battery without | — | — | 188 cycles |
| graphene coating | | | @80% |
| Battery subject to even | 1.7 | 1.7 | 278 cycles |
| keel graphene coating | | | @80% |
| for 5 times | | | |
| Battery subject to | 8.4 | 1.7 | 279 cycles |
| suspension graphene | | | @80% |
| coating for 5 times | | | |

“188 cycles @80%” means the battery maintains 80% capacity for 188 cycles.
“278 cycles @80%” means the battery maintains 80% capacity for 278 cycles.
“279 cycles @80%” means the battery maintains 80% capacity for 279 cycles.

As shown in FIG. 2, a graphene protection layer can be formed on a cathode surface via the method of the present disclosure, thus enhancing the cycle performance of the battery.

In the description presented herein, reference may be made to manganese-based cathode aqueous rechargeable zinc batteries. However, the compositions described may be applicable to other cells and batteries which are not zinc based. Various embodiments of the battery include zinc as the anode, and a manganese-based cathode.

According to an embodiment of the present invention, a method of making an electrode with protection layers for a rechargeable battery is provided. Typically, rechargeable batteries comprise at least one cathode, one anode, a composite separator and an electrolyte.

According to an embodiment of the present disclosure, the electrode is a cathode.

Preferably, the cathode comprises a collector; and, a cathode material layer located on the surface of the collector (namely, a layer composed of cathode active materials). The protection layer of the present disclosure preferably is located on the surface of the cathode material layer away from the collector.

Any negative pole current collector known to those skilled in the art can be selected accordingly without any special restrictions. As the carrier of electron conduction and collection, the negative pole current collector typically does not participate in the electrochemical reaction, that is, within the range of operating voltage of the battery, the negative pole current collector can stably exist in the electrolyte solution without any side reactions, so as to ensure the stable cycle performance of the battery. The size of the negative pole current collector can be determined according to the use of the battery. For example, a large-area negative pole current collector can be used for a large battery that requires a high energy density. There is no special restriction on the thickness of the negative pole current collector, typically about 1-100 μm. There is also no special restriction on the shape of the negative pole current collector. For example, it can be a rectangle or a circle. There is no special restriction on the raw materials of the cathode collector, which may be selected from aluminum, titanium, silver, cobalt, aluminum alloy, stainless steel, copper alloy and titanium alloy are all available. Preferably the cathode collector is selected from aluminum, titanium, aluminum alloy and stainless steel.

In an embodiment of the present disclosure, when the electrode is a cathode, the cathode can be prepared by the following method: mixing cathode active materials, conductive agent, an adhesive and a solvent; stirring uniformly to obtain a cathode paste; applying the cathode paste on to a collector and then drying the collector, thus to obtain the electrode.

In a typical embodiment, the cathode is prepared by the following method: mixing cathode active materials, conductive agent, an adhesive and a solvent; mechanically stirring for 2 h to obtain a cathode mixture. Then, filtering the cathode mixture via a screen to obtain a cathode paste. Next, casting or coating the cathode paste on to a cathode collector and then drying the collector, thus to obtain the cathode.

The cathode active material can be formed on either one side or both sides of the cathode collector. The cathode active material may comprise at least one or more materials with Li₁₊ₓMn_{y}M_{z}Oₖ as the chemical formula, where −1≤x≤0.5, 1≤y≤2.5, 0≤z≤1 and 3≤k≤6. In an embodiment, the cathode active material can be selected from at least one or more of LiMn₂O₄ and MnO₂. These manganese-based cathode aqueous rechargeable zinc batteries are usually restricted in terms of their performance, and also reflect poor cycle performance during constant charging and recharging. This can be attributed to the formation of inert by-products on the cathode due to the dissolution of manganese ions into the electrolyte, and to the accumulation of lithium ions on the cathode surface due to the Jahn-Teller distortion effect, which can limit the battery life. In addition, the decomposition of H₂O (2H₂O→O₂+4H⁺+4e⁻)—common side reaction in these batteries—can also shorten the battery life. Conductive network failure can be attributed to the oxidation of conductive agent (C) (C+2H₂O→CO₂+4H⁺+4e⁻ under lower potential; C+xO₂→COₓ under high potential). Therefore, applying a protection layer on the cathode is conductive to enhance cycle performance.

The conductive agent may comprise at least one or more materials selected from activated carbon, carbon black, graphene, graphite, carbon nanotube, carbon fiber and conductive polymer. Preferably, the conductive agent may include at least one or more materials selected from active carbon, carbon black, graphene and carbon nanotube.

The adhesive may comprise at least one or more materials selected from polyethylene oxide, polypropylene oxide, polyacrylonitrile, polyimide, polyester, polyether, fluorinated polymer, polydiethylene glycol, polyethylene glycol diacrylate, polyethylene glycol diacrylate and its derivatives. Preferably, the adhesive may include at least one or more materials selected from polyvinylidene fluoride, polytetrafluoroethylene and styrene-butadiene rubber.

The solvent may comprise at least one or more materials such as water, alcohol, ester, carbonate, ether and ketone. Preferably, the solvent may include at least one or more of water, ethanol, acetone and N-methyl-2-pyrrolidone.

The separator as used “herein” can be defined as a separator system having at least one layer that provides separation and/or diffusion differentiation barrier between the electrodes.

Below, exemplary examples will be described in detail so as to be easily realized by a person having ordinary knowledge in the art. The disclosure concept may be embodied in various forms without being limited to the exemplary examples set forth herein. Descriptions of well-known parts are omitted for clarity.

### Example 1

150 g LiMn₂O₄, 3.2 g carbon block, 22.2 g carbon nanotube, 6.3 g styrene-butadiene rubber and water were mechanically stirred and mixed under 1500 rpm for 2 hours. The resulted mixture was then filtered with mesh wire to obtain the cathode slurry. The cathode was prepared by casting the slurry on titanium foil. After drying, square cathode plate was cut with 44.5 mm*73.5 mm.

10 mg of reduced graphene oxide was weighed and 50 mL of ethanol was added, the resulted solution was stirred at room temperature for 30 minutes subsequently followed by an ultrasonic treatment for 30 minutes. After that, another 350 mL of ethanol was added and the solution was continued to magnetically stir at room temperature for 30 minutes to obtain a uniform and well-proportioned solution. The cathode was then immersed perpendicularly toward the reduced graphene oxide solution with a constant speed of 8.4 mm/s, after all parts of the cathode dipping into the solution, the cathode was kept still for 10 seconds before the cathode was perpendicularly withdrawn with a constant speed of 1.7 mm/s. After drying at 50° C. for 5 minutes, the above-mentioned dipping process was repeated for 4 more times to treat the cathode, the resulted cathode was then dried at 50° C. overnight. Then, the cathode, the zinc plate and the separator were assembled to fabricate a battery cell and soaked in electrolyte solution under reduced pressure for the charging and discharging tests.

The electrolyte is an aqueous solution of zinc sulfate and lithium sulfate. Charging procedure: charging the 0.5C battery to 2.05V under constant current and then to 0.05C under constant voltage, standing for 3 min; discharging procedure: discharging the 0.5C battery to 1.4V under constant current, standing for 3 min.

The resulting battery unit has a specific discharge capacity of 87.9 mAh/g. At a charging/discharging rate of 0.5C, the battery maintains 80% capacity for 237 cycles.

### Example 2

150 g LiMn₂O₄, 3.2 g carbon block, 31.9 g carbon nanotube, 6.7 g styrene-butadiene rubber and water were mechanically stirred and mixed under 1500 rpm for 2 hours. The resulted mixture was then filtered with mesh wire to obtain the cathode slurry. The cathode was prepared by casting the slurry on titanium foil. After drying, square cathode plate was cut with 44.5 mm*73.5 mm.

30 mg of reduced graphene oxide was weighed and 50 mL of ethanol was added, the resulted solution was stirred at room temperature for 30 minutes subsequently followed by an ultrasonic treatment for 30 minutes. After that, another 350 mL of 1,2-dichloroethane was added and the solution was continued to magnetically stir at room temperature for 30 minutes to obtain a uniform and well-proportioned solution. The cathode was then immersed or moved down perpendicularly toward the 500 mL water with a constant speed of 1.7 mm/s. After the cathode was completely immersed or dipped into the solution, 0.04 mL reduced graphene oxide solution was added to the water. Then the cathode was immobilized for 60 seconds before the cathode was perpendicularly withdrawn with a constant speed of 1.7 mm/s. After drying at 50° C. for 5 minutes, the above-mentioned dipping process was repeated for 4 more times to treat the cathode, the resulted cathode was then dried at 50° C. overnight. Then, the cathode, the zinc plate and the separator were assembled to fabricate a battery cell and soaked in electrolyte solution under reduced pressure for the charging and discharging tests.

The electrolyte is an aqueous solution of zinc sulfate and lithium sulfate. Charging procedure: charging the 0.5C battery to 2.05V under constant current and then to 0.05C under constant voltage, standing for 3 min; discharging procedure: discharging the 0.5C battery to 1.4V under constant current, standing for 3 min.

The resulting battery unit has a specific discharge capacity of 94.9 mAh/g. At a charging/discharging rate of 0.5C, the battery maintains 80% capacity for 278 cycles.

### Example 3

150 g LiMn₂O₄, 3.2 g carbon block, 31.9 g carbon nanotube, 6.7 g styrene-butadiene rubber and water were mechanically stirred and mixed under 1500 rpm for 2 hours. The resulted mixture was then filtered with mesh wire to obtain the cathode slurry. The cathode was prepared by casting the slurry on titanium foil. After drying, square cathode plate was cut with 44.5 mm*73.5 mm.

30 mg of reduced graphene oxide was weighed and 50 mL of ethanol was added, the resulted solution was stirred at room temperature for 30 minutes subsequently followed by an ultrasonic treatment for 30 minutes. After that, another 350 mL of 1,2-dichloroethane was added and the solution was continued to magnetically stir at room temperature for 30 minutes to obtain a uniform and well-proportioned solution. The cathode was then immersed and moved down perpendicularly toward the reduced graphene oxide solution with a constant speed of 8.4 mm/s, after all parts of the cathode were completely immersed into the solution, the cathode was kept still for 10 seconds before the cathode was perpendicularly withdrawn with a constant speed of 1.7 mm/s. After drying at 50° C. for 5 minutes, the above-mentioned dipping process was repeated for 4 more times to treat the cathode, the resulted cathode was then dried at 50° C. overnight. Then, the cathode, the zinc plate and the separator were assembled to fabricate a battery cell and soaked in electrolyte solution under reduced pressure for the charging and discharging tests.

The electrolyte is an aqueous solution of zinc sulfate and lithium sulfate. Charging procedure: charging the 0.5C battery to 2.05V under constant current and then to 0.05C under constant voltage, standing for 3 min; discharging procedure: discharging the 0.5C battery to 1.4V under constant current, standing for 3 min.

The resulting battery unit has a specific discharge capacity of 84.8 mAh/g. At a charging/discharging rate of 0.5C, the battery maintains 80% capacity for 279 cycles.

### Example 4

150 g LiMn₂O₄, 3.2 g carbon block, 22.3 g carbon nanotube, 6.6 g styrene-butadiene rubber and water were mechanically stirred and mixed under 1500 rpm for 2 hours. The resulted mixture was then filtered with mesh wire to obtain the cathode slurry. The cathode was prepared by casting the slurry on titanium foil. After drying, square cathode plate was cut with 44.5 mm*73.5 mm.

250 mg of graphene was weighed and 250 mL of ethanol was added, the resulted solution was stirred at room temperature for 30 minutes subsequently followed by an ultrasonic treatment for 30 minutes. After that, the solution was continued to magnetically stir at room temperature for 30 minutes to obtain a uniform and well-proportioned solution. The cathode was then moved down perpendicularly toward the graphene solution with a constant speed of 8.4 mm/s, after all parts of the cathode dipping into the solution, the cathode was kept still for 10 seconds before the cathode was perpendicularly moved out with a constant speed of 8.4 mm/s. After drying at 50° C. for 5 minutes, the above-mentioned dipping process was repeated for 4 more times to treat the cathode, the resulted cathode was then dried at 50° C. overnight. Then, the cathode, the zinc plate and the separator were assembled to fabricate a battery cell and soaked in electrolyte solution under reduced pressure for the charging and discharging tests.

The electrolyte is an aqueous solution of zinc sulfate and lithium sulfate. Charging procedure: charging the 1C battery to 2.05V under constant current and then to 0.05C under constant voltage, standing for 3 min; discharging procedure: discharging the 0.5C battery to 1.4V under constant current, standing for 3 min.

The resulting battery unit has a specific discharge capacity of 104.6 mAh/g. At a charging/discharging rate of 1C/0.5C, the battery maintains 80% capacity for 284 cycles.

### Example 5

150 g LiMn₂O₄, 3.2 g carbon block, 22.3 g carbon nanotube, 6.6 g styrene-butadiene rubber and water were mechanically stirred and mixed under 1500 rpm for 2 hours. The resulted mixture was then filtered with mesh wire to obtain the cathode slurry. The cathode was prepared by casting the slurry on titanium foil. After drying, square cathode plate was cut with 44.5 mm*73.5 mm.

250 mg of graphene oxide was weighed and 250 mL of ethanol was added, the resulted solution was stirred at room temperature for 30 minutes subsequently followed by an ultrasonic treatment for 30 minutes. After that, the solution was continued to magnetically stir at room temperature for 30 minutes to obtain a uniform and well-proportioned solution. The cathode was then moved down perpendicularly toward the graphene oxide solution with a constant speed of 8.4 mm/s, after all parts of the cathode dipping into the solution, the cathode was kept still for 10 seconds before the cathode was perpendicularly moved out with a constant speed of 1.7 mm/s. After drying at 50° C. for 5 minutes, the above-mentioned dipping process was repeated for 4 more times to treat the cathode, the resulted cathode was then dried at 50° C. overnight. Then, the cathode, the zinc plate and the separator were assembled to fabricate a battery cell and soaked in electrolyte solution under reduced pressure for the charging and discharging tests.

The electrolyte is an aqueous solution of zinc sulfate and lithium sulfate. Charging procedure: charging the 1C battery to 2.05V under constant current and then to 0.05C under constant voltage, standing for 3 min; discharging procedure: discharging the 0.5C battery to 1.4V under constant current, standing for 3 min.

The resulting battery unit has a specific discharge capacity of 100 mAh/g. At a charging/discharging rate of 1C/0.5C, the battery maintains 80% capacity for 173 cycles. In case of the cathode without graphene coating at the same rate, the battery maintains 80% capacity for 147 cycles.

### Reference 1

150 g LiMn₂O₄, 3.2 g carbon block, 31.9 g carbon nanotube, 6.7 g styrene-butadiene rubber and water were mechanically stirred and mixed under 1500 rpm for 2 hours. The resulted mixture was then filtered with mesh wire to obtain the cathode slurry. The cathode was prepared by casting the slurry on titanium foil. After drying, square cathode plate was cut with 44.5 mm*73.5 mm.

30 mg of reduced graphene oxide was weighed and 250 mL of ethanol was added, the resulted solution was stirred at room temperature for 30 minutes subsequently followed by an ultrasonic treatment for 30 minutes. After that, the solution was continued to magnetically stir at room temperature for 30 minutes to obtain a uniform and well-proportioned solution. The cathode was then moved down perpendicularly toward the reduced graphene oxide solution with a constant speed of 10 mm/s, after all parts of the cathode dipping into the solution, the cathode was kept still for 10 seconds before the cathode was perpendicularly moved out with a constant speed of 10 mm/s. After drying at 50° C. for 3 minutes, the above-mentioned dipping process was repeated for 4 more times to treat the cathode, the resulted cathode was then dried at 50° C. Then, the cathode, the zinc plate and the separator were assembled to fabricate a battery cell and soaked in electrolyte solution under reduced pressure for the charging and discharging tests.

The electrolyte is an aqueous solution of zinc sulfate and lithium sulfate. Charging procedure: charging the 0.5C battery to 2.05V under constant current and then to 0.05C under constant voltage, standing for 3 min; discharging procedure: discharging the 0.5C battery to 1.4V under constant current, standing for 3 min.

Compared to the control battery without graphene coating, this battery has no improvement in cycle performance at a charging/discharging rate of 0.5C. The control battery without graphene coating has a life of 188 cycles under 80% capacity, while the battery treated via this process has a life of 183 cycles under 80% capacity.

### Reference 2

150 g LiMn₂O₄, 3.2 g carbon block, 22.3 g carbon nanotube, 6.6 g styrene-butadiene rubber and water were mechanically stirred and mixed under 1500 rpm for 2 hours. The resulted mixture was then filtered with mesh wire to obtain the cathode slurry. The cathode was prepared by casting the slurry on titanium foil. After drying, square cathode plate was cut with 44.5 mm*73.5 mm.

250 mg of graphene was weighed and 250 mL of ethanol was added, the resulted solution was stirred at room temperature for 30 minutes subsequently followed by an ultrasonic treatment for 30 minutes. After that, the solution was continued to magnetically stir at room temperature for 30 minutes to obtain a uniform and well-proportioned solution. The cathode was then moved down perpendicularly toward the graphene solution with a constant speed of 0.5 mm/s, after all parts of the cathode dipping into the solution, the cathode was kept still for 10 seconds before the cathode was perpendicularly moved out with a constant speed of 0.5 mm/s. After drying at 50° C. for 5 minutes, the above-mentioned dipping process was repeated for 4 more times to treat the cathode, the resulted cathode was then dried at 50° C. overnight. Then, the cathode, the zinc plate and the separator were assembled to fabricate a battery cell and soaked in electrolyte solution under reduced pressure for the charging and discharging tests.

The electrolyte is an aqueous solution of zinc sulfate and lithium sulfate. Charging procedure: charging the 1C battery to 2.05V under constant current and then to 0.05C under constant voltage, standing for 3 min; discharging procedure: discharging the 0.5C battery to 1.4V under constant current, standing for 3 min.

The resulting battery unit has a specific discharge capacity of 96.7 mAh/g. At a charging/discharging rate of 1C/0.5C, the battery maintains 80% capacity for 40 cycles. In case of the control battery without graphene coating at the same rate, the battery maintains 80% capacity for 147 cycles.

The previously described invention has many advantages. The advantages include safe, efficient, novel inexpensive methods of making electrode(s) with protective layers for use in aqueous rechargeable zinc batteries which offer significant protection against battery capacity fading, while enhancing cycling stability during recharging of the battery that will overcome the limitations of traditional shortened cycle life of batteries. These cathode protective layers make them especially valuable in meeting the growing demands to find compact power sources specifically with long-life solutions in grid storage.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A method of making an electrode with protection layers, the method comprising the steps of:
a) withdrawing an immersed electrode from a coating liquid at an angle perpendicular to a surface of the coating liquid at a speed from about 1 mm/s to about 9 mm/s to form a coated electrode; and,
b) drying the coated electrode to obtain the electrode with protection layers;
wherein the coating liquid comprises a dispersion liquid;
whereby the dispersion liquid comprises one or more of graphene, a graphene derivative and combinations thereof.

2. The method of making an electrode with protection layers of claim 1, wherein the coating liquid comprises an upper layer and a lower layer;
the upper layer comprising the dispersion liquid, and the lower layer comprising water.

3. The method of making an electrode with protection layers of claim 1, wherein the coating liquid is a dispersion liquid.

4. The method of making an electrode of claim 1, wherein the dispersion liquid is formed by a method comprising the steps of:
forming a reaction mixture comprising one or more of the graphene, the graphene derivative or combinations thereof, and a first solvent;
stirring the reaction mixture;
subjecting the reaction mixture to ultrasonic treatment;
adding a second solvent to the reaction mixture to form the dispersion liquid.

5. The method of making an electrode with protection layers of claim 4, wherein the first solvent comprises water, alcohol, ester and ketone; and, the second solvent comprises a water, alcohol, haloalkane, ether and ketone.

6. The method of making an electrode with protection layers of claim 5, wherein the first solvent comprises methanol, ethanol, isopropanol and acetone; and, the second solvent comprises ethanol, 1, 2-dichloroethane, chloroform and acetone.

7. The method of making an electrode with protection layers of claim 4, wherein the volume ratio of the first solvent to that of the second solvent is from about 1:1 to about 1:20.

8. The method of making an electrode with protection layers of claim 7, wherein the volume ratio of the first solvent to that of the second solvent is from about 1:5 to about 1:15.

9. The method of making an electrode with protection layers of claim 1, wherein the graphene, the graphene derivative or combinations thereof, is present in the dispersion liquid in a concentration from about 0.025 mg/mL to about 1 mg/mL.

10. The method of making an electrode with protection layers of claim 9, wherein the graphene, the graphene derivative or combinations thereof, is present in the dispersion liquid in a concentration from about 0.075 mg/mL to about 1 mg/mL.

11. The method of making an electrode with protection layers of claim 1, wherein the step of withdrawing the immersed electrode from the coating liquid at an angle perpendicular to the surface of the coating liquid is at a uniform speed.

12. The method of making an electrode with protection layers of claim 1, further comprising the steps of:
immersing an electrode into a coating liquid at an angle perpendicular to a surface of the coating liquid at a uniform speed from about 1 mm/s to about 9 mm/s to form the immersed electrode;
prior to the step of withdrawing step (a).

13. The method of making an electrode with protections layers of claim 12, wherein the period of time is from about 5 seconds to about 60 seconds.

14. The method of making an electrode with protection layers of claim 1, wherein the graphene derivative is graphene oxide or reduced graphene oxide, and wherein the electrode is a cathode.

15. A method of making an electrode with protection layers, the method comprising the steps of:
a) immersing an electrode into a coating liquid at an angle perpendicular to a surface of the coating liquid at a uniform speed from about 1 mm/s to about 9 mm/s to form the immersed electrode;
b) withdrawing the immersed electrode from the coating liquid at an angle perpendicular to a surface of the coating liquid at a uniform speed from about 1 mm/s to about 9 mm/s to form a coated electrode; and,
c) drying the coated electrode to obtain the electrode with protection layers;
wherein the coating liquid comprises a dispersion liquid;
whereby the dispersion liquid comprises one or more of graphene, a graphene derivative and combinations thereof.

16. The method of making an electrode with protection layers of claim 15 repeating steps a)-c) at least once to obtain the electrode with protection layers.

17. The method of making an electrode with protection layers of claim 15, wherein the electrode is a cathode, and wherein the graphene derivative is graphene oxide or reduced graphene oxide.

18. The method of making an electrode with protection layers of claim 17, further comprising the steps of:
forming a reaction mixture comprising a cathode active material, a conductive agent, an adhesive and a solvent to obtain a cathode paste;
applying the cathode paste to a collector; and,
drying the collector to obtain the cathode.

19. The method of making an electrode with protection layers of claim 18, wherein the cathode active material contains at least one or more material(s) with formula Li₁₊ₓMn_{y}M_{z}Oₖ, wherein −1≤x≤0.5, 1≤y≤2.5, 0≤z≤1 and 3≤k≤6.

20. The method of making an electrode with protection layers of claim 19, wherein the cathode active material is selected from at least one of LiMn₂O₄ and MnO₂.
